(19) United States
(12) Patent Application Publication
(10) Pub. No.: US 2007/0168316 A1
(43) Pub. Date: Jul. 19, 2007

(54) Publication activation service

(75) Inventors: Amit Gupta, Kirkland, WA (US); Andrew J. Jaffray, Seattle, WA (US); Elizabeth Anne Hill, Kirkland, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/332,540

(22) Filed: Jan. 13, 2006

(51) Int. Cl. G06F 17/30; G06F 7/00

(52) U.S. Cl. 707/1; 707/200

(57) ABSTRACT

Updating a database while minimizing resources on a database server instance. One or more indexes are created prior to propagating updated data associated with the database to a computing device associated with the database server instance for access.

### BACKGROUND

With the emergence of the Internet and the interconnection of devices utilized in most every aspect of modem life, a wide range of data has become available of an almost limitless diversity. Internet content may be thought of as data that has intrinsic value to a subset of users of web sites, internet client devices, client devices that connect to the internet, and the like. This data can be configured to more efficiently address and therefore be of greater value to the subset of users. In many cases, this greater value is created as a result of some type of data processing, typically in the form of a sequence of stages or steps, which may be implemented through use of a pipeline. A pipeline includes one or more stages, which may provide manipulation of sets of data, combine multiple sets of data into a single set of data through interlinking related data, and the like. Often, an output of a stage of a pipeline will serve as input to multiple subsequent stages, each of which may represent a beginning of a new pipeline and/or a continuation of the same pipeline. Since each pipeline stages relies on the availability of data from a preceding stage in the pipeline, it is very important to have a reliable system for consuming input data and producing output data for subsequent stages.

Because of the wide range of data available from the Internet, systems utilizing a large number of pipelines may be utilized to manipulate the data through use of the various stages. In some systems, for example, pipelines are interconnected with other pipelines through interconnected stages, resulting in a large and intricate system of pipelines, such that execution of the pipelines demands a significant amount of computer resources. Execution of pipelines may include performing services included in stages of the pipeline, such as interlinking related data, and the like. Because of business demands such as timeliness due to a competitive nature of a particular industry and/or frequency of data updates or changes, execution of stages for a pipeline is accomplished as fast as possible with a high reliability to remain competitive in the industry.

In some systems, the output of a pipeline includes the publication of several multi-gigabyte databases that are under constant access by users. For example, the pipeline may represent a data service responsible for returning metadata about media content to components of an operating system or other clients in real-time. This data service should have high availability and should return data that is current (e.g., regularly updated). Updating the data in these large, heavily utilized databases, however, often significantly disrupts service to the users in part because some previous systems use replication to propagate data through each stage in the pipeline. As known in the art, replication does not move the indexes associated with the databases. Indexes enable fast retrieval of the data in a database. As such, after the data is replicated to the front-end servers (e.g., the servers servicing user requests for data), the indexes are created simultaneously on all the front-end servers for a period of time (e.g., fifteen to twenty minutes). Creating the indexes in this manner consumes front-end server resources including processor time and memory. Contention issues result as the front-end servers attempt to service user requests for data while creating the indexes.

### SUMMARY

Embodiments of the invention publish large database updates to constantly accessed databases in a production environment. In an embodiment, the invention provides a publication activation service (PAS) for managing database updates without an interruption to users. Indexes associated with updated databases are created on servers other than the front-end servers that respond to client requests for data. The created indexes are then propagated to the front-end servers. Clients experience minimal downtime from the front-end servers in part because there is minimal processor impact to the front-end servers during the database update.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating the interaction between the publication activation service, data centers, and users.

FIG. 2 is an exemplary block diagram illustrating servers accessing an online database and an offline database via a toggle.

FIG. 3 is an exemplary block diagram illustrating a pipeline.

FIG. 4 is an exemplary flow chart illustrating operation of the publication activation service.

FIG. 5 is an exemplary block diagram illustrating propagation of updates from back end servers to front-end servers.

FIG. 6A, FIG. 6B, FIG. 6C, and FIG. 6D are exemplary flow charts illustrating detailed operation of the publication activation service.

FIG. 7 is a block diagram illustrating the publication activation service accessing an install specification file.

Corresponding reference characters indicate corresponding parts throughout the drawings.

### DETAILED DESCRIPTION

In an embodiment, the invention includes database management and user experience improvements for the maintenance of a multi-server online metadata service. A publication activation service (PAS) operates to perform database updates while minimizing database downtime in part by creating indexes for the databases before propagating the data to front-end database server instances (e.g., database servers). In one embodiment, there is one instance of PAS for each type of published data.

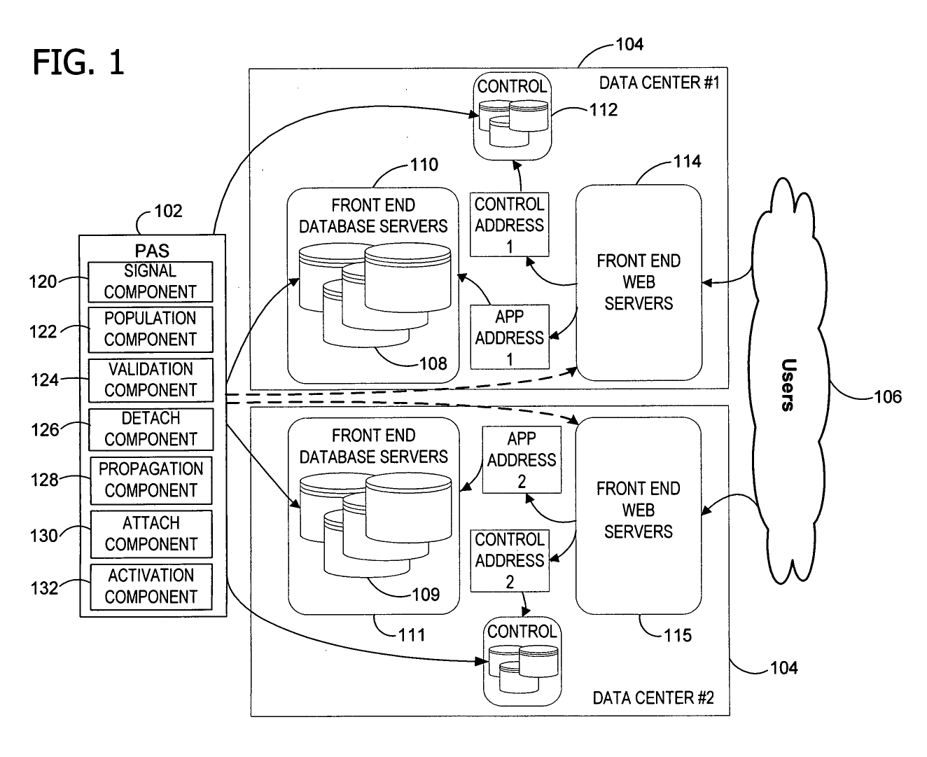

Referring first to FIG. 1, an exemplary block diagram illustrates the interaction between the PAS 102, data centers 104 such as data center #1 and data center #2, and users 106. In FIG. 1, the PAS 102 propagates data to update databases 108, 109 in the front-end database servers 110, 111 in the data centers 104 (e.g., clusters). The PAS 102 updates control tables 112, 113 in each of the data centers 104 to point to the updated databases 108, 109. The front-end web servers 114, 115 access data in the updated databases 108, 109 responsive to requests for data from users 106 or clients such as operating system components, application programs, and the like. In one embodiment, the system of FIG. 1 manages the configuration and addition or removal of new servers 110, 111 into and out of existing clusters, as well as the addition or deletion of new clusters.

The PAS 102 may include one or more computer-executable components stored on one or more computer-readable media. In one embodiment, the components include a signal component 120, a population component 122, a validation component 124, a detach component 126, a propagation component 128, an attach component 130, and an activation component 132. The signal component 120 receives an indication of an update to a data file associated with a database such as database 108, 109. The population component 122 creates an index based on the updated data file. The validation component 124 validates the updated data file, the indexes created by the population component 122, and/or the consistency of the control database 112, 113. The detach component 126 removes the inactive database from the database server instance. For example, the detach component 126 may remove database files. The propagation component 128 replaces the database files removed by the detach component 126 with the updated data file (including the indexes). The attach component 130 associates the updated data file and the indexes with the database server instance 110, 111 in place of the database files to update the inactive database. The activation component 132 activates the newly updated database and notifies the front-end web server 114, 115 to access the updated database.

In one example, a system such as illustrated in FIG. 1 implements a metadata service to provide metadata about media content to a media player application program. Each time a user plays a compact disc (CD) via the media player, the media player contacts the metadata service to obtain available metadata (e.g., CD information) such as title, artist, cover art, track names, and the like. The metadata service aggregates the CD information from a number of different sources, for example, on a daily basis and publishes it to the front-end servers as shown in FIG. 1.

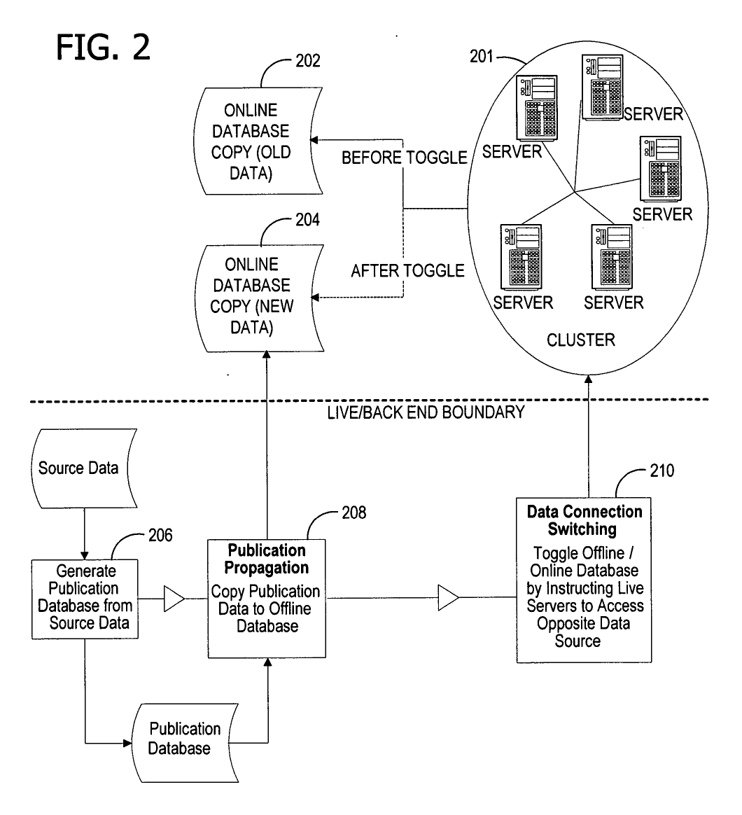

Referring next to FIG. 2, an exemplary block diagram illustrates servers in a cluster 201 accessing an online database 202 and an offline database 204 via a toggle. In FIG. 2, the PAS generates a publication database from source data at 206 and propagates the publication database to an offline database at 208. When the offline database is completely updated, the PAS implements data connection switching to toggle access (e.g., redirect data requests) by servers in a cluster between an online database and the offline database at 210.

Aspects of the invention are operable in a system such as illustrated in FIG. 2 in which multiple copies of each database are maintained and managed. Updates to a database occur while users access one or more database copies. The system in FIG. 2 operates without manual intervention from operators, is resilient to errors, provides data validation, version tracking, and is capable of reporting errors while maintaining data integrity.

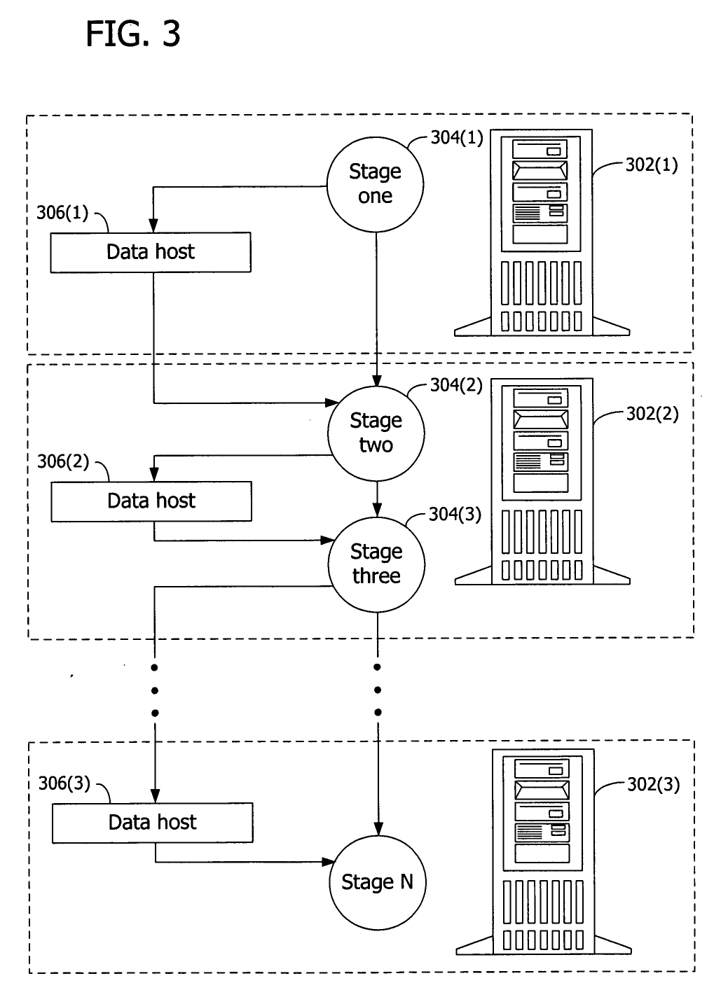

Referring next to FIG. 3, an exemplary block diagram illustrates a pipeline having multiple stages. In an embodiment, the invention propagates data between content pipeline stages. Each content pipeline stage includes one stage with one or more input pipes, processing and one or more output pipes. After a stage completes its processing, the stage generates the outputs to be consumed by the subsequent stages.

In FIG. 3, a system is configured for implementing a pipeline. Systems implementing pipelines may be configured in a variety of ways. For instance, considerations such as processing power, network connections, type of data, destination for data, and the like, may be addressed to provide a system of pipelines which correspond to a developer's needs. As shown in FIG. 3, a system implementing a pipeline may include multiple computers, computing devices, or the like 302(1), 302(2), 302(3) implementing first, second and third stages 304(1), 304(2), 304(3) and data stores 306(1), 306(2), 306(3). A first stage 304(1), and a first data host 306(1) communicatively coupled to the first stage 304(1), are implemented on a first computer 302(1). The first computer 302(1) is communicatively coupled to a second computer 302(2) which operates to host a second stage 304(2), a third stage 304(3), and a second data host 306(2). The second stage 304(2), implemented on the second computer 302(2), may access the first data host 306(1) implemented on the first computer 302(1), which receives the output of the first stage 304(1). Likewise, the third stage 306(3) transfers its output to a third data host 306(3) implemented on a third computer 302(3).

In general, a propagation mechanism according to the invention is operable with one or more of the following pipelines: a content selection pipeline, an event processing pipeline, a direct mailer pipeline, an order processing pipeline, a product pipeline, a plan pipeline, a purchase pipeline, any system where an uninterrupted update to a front-end server is desired regularly, and any system where data is flowing from one stage to another. In one embodiment, a propagation mechanism according to the invention communicates television guide listing data, music metadata, games metadata, digital versatile disc (DVD) metadata, or the like from back end to front-end for user access.

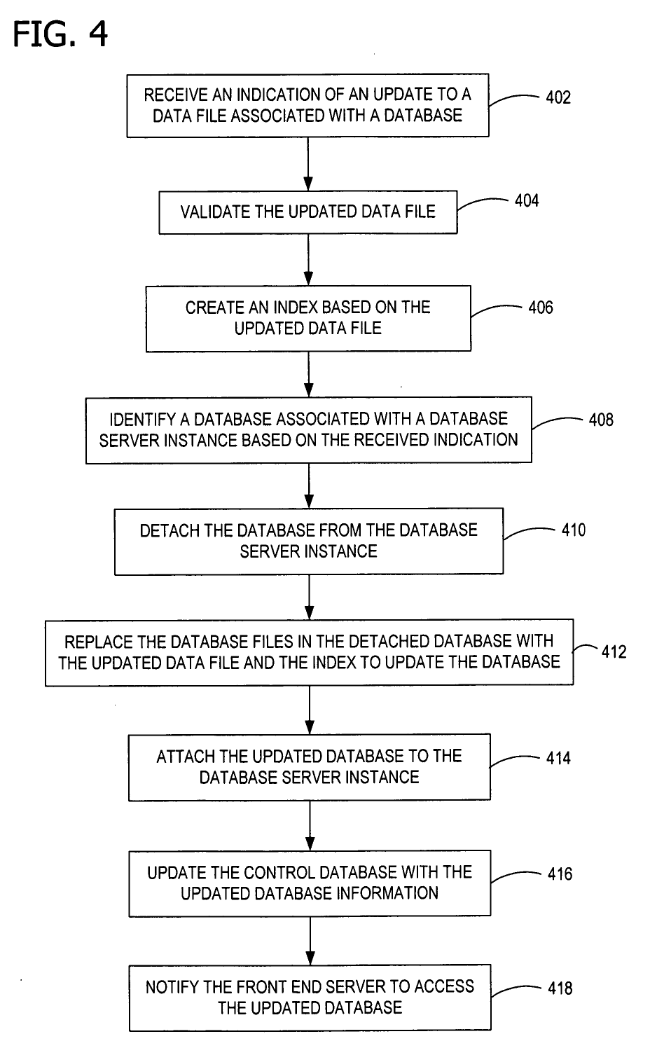

Referring next to FIG. 4, an exemplary flow chart illustrates operation of the publication activation service. The method illustrated in FIG. 4 receives an indication of an update to a data file associated with a database at 402. The method validates the control database and the updated data files at 404. In one embodiment, the method creates indexes based on the updated data file on at least one of the back end servers at 406. In another embodiment, the indexes are created by another component and then received by the publication activation service. An index is a catalog of the data files to enable searching of the data files. The method further identifies the databases on the front-end servers that correspond to the data file in the received indication at 408. In one embodiment, the method further confirms that the identified databases are inactive, offline, or otherwise not in use by the front-end servers. The method detaches the identified databases from database server instances associated with the identified databases at 410. In one embodiment, detaching a database removes database files from an instance of a database server. The method further replaces the database files in each of the detached databases with the updated database files (including the indexes) to update each of the databases at 412. The method attaches each of the updated databases to the corresponding database server instances at 414. In one embodiment, attaching a database associates database files with a database server instance and updates the control database with the updated database information at 416. The method further notifies the web server instances to access the updated databases at 418. Alternatively or in addition, the method maintains version information related to the updated data file, performs checksums throughout the propagation to ensure data integrity, and provides monitoring events for logging purposes.

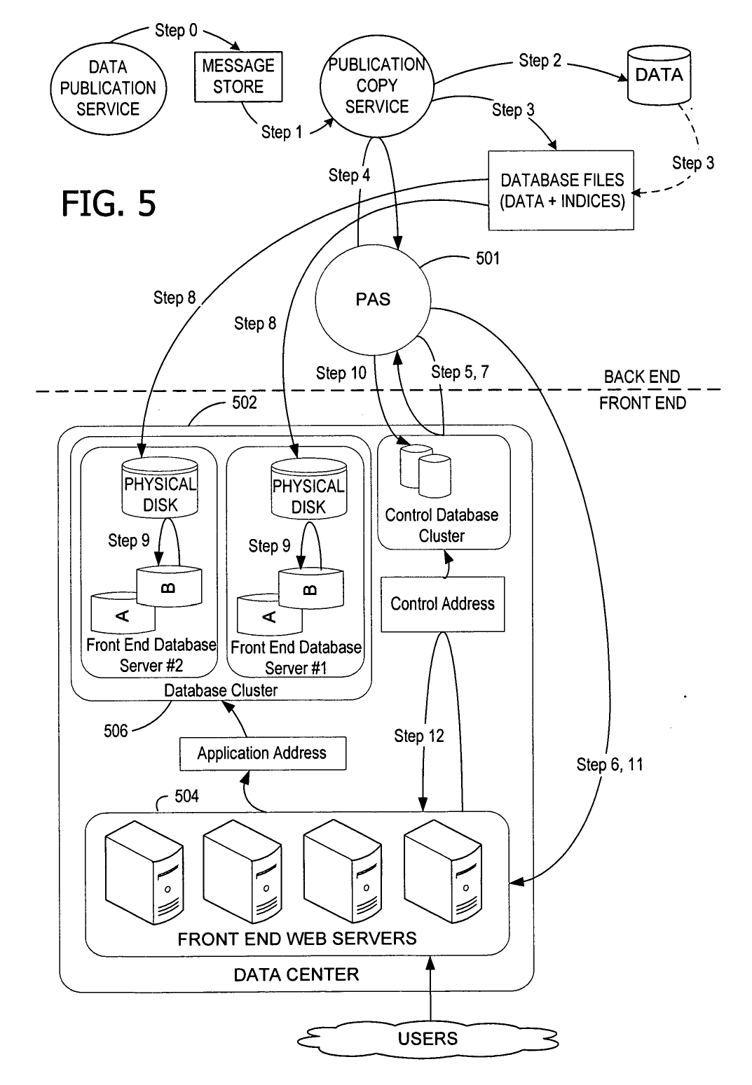

Referring next to FIG. 5, an exemplary block diagram illustrates propagation of updates from back end servers to front-end servers 504 by the publication activation service (PAS) 501. While only one data center 502 is shown in the embodiment of FIG. 5, other embodiments include a plurality of data centers. A backend publication system (e.g., a data publication service) creates the database to be published. A process moves the data from the backend publication stages to the front-end servers 504 via a copy-attach approach. A control database in a control database cluster on the front-end retains state information (e.g., keeps track of the active databases, maintains knowledge about the machines in a cluster). For example, by knowing the list of databases in each data center 502 or cluster, operation of the system continues even if there is a database failure in one of the data centers 502. A task redirects the front-end servers 504 to use the updated publications (e.g., via a secure SOAP based web service). Robust failure handling is resilient for handling inconsistent control data, detach/copy/attach failures, and task invoke failures.

In one embodiment, when the PAS 501 starts, it reads the following information from configuration: a list of all machines which form at least one cluster 506 of database servers where the control table is held, a list of all machines which form at least one cluster of front-end servers 504, and the list of front-end servers 504 that use a particular publication to be updated.

When the data publication service for the publication to be updated completes at Step 0, the data publication service updates a message store to indicate completion of the publication. A publication copy/create service detects that the publication is complete at Step 1 and copies the data tables comprising the publication to an output database. The publication copy/create service (or the publication activation service 501 in another embodiment) also creates one or more indexes for the output database at Step 2. The publication copy/create service creates an output pipe of database files (e.g., data files and index files) at Step 3 to be consumed by the PAS 501. The PAS 501 detects that the publication onto the output pipe is complete at Step 4. The PAS 501 reads from the control table in each control database cluster at Step 5 to determine which database (e.g., database A or database B in this example) is live or active. In one embodiment, the process continues at Step 6 only if all servers in the control database clusters have the same value. At Step 6, if the PAS 501 is unable to get the inactive/active database information from the control database, then the PAS 501 attempts to get the information directly from the front-end web servers 504. If the PAS 501 is unable to obtain the inactive/active database information from the front-end servers 504, the PAS 501 attempts to force the front-end servers to use the database retrieved from step 5 by updating the control database clusters at Step 7 to ensure that no front-end server 504 is using the database to be updated. Alternatively, if the PAS 501 is unable to obtain the inactive database information from the control database and obtains the active database information from the front-end servers 504, the PAS 501 updates all the control databases at Step 7 with the active/inactive database information retrieved from the front-end servers 504.

At Step 8, the PAS 501 detaches or otherwise removes the inactive database on the front-end servers 504 and invokes a copy of the detached database from the publication copy service stage to all front-end servers 504. In this manner, there will be a maximum of two copies of the database on the front-end. The copy location is determined from a configuration file. In one embodiment, Step 8 is a multi-threaded process where the quantity of simultaneous threads is configurable and each thread performs synchronous copy to a single front-end server 504. After copy completion, the newly copied file is attached at Step 9 with the same name as the replaced file and permissions to the newly attached database are granted. At Step 10, the PAS 501 updates the control table in each of the control database clusters to reflect the newly attached database name (e.g., A or B in FIG. 5). The PAS 501 invokes a task (e.g., an active server page) at Step 11 on each of the front-end servers 504 that use the publication. At Step 12, each task reads information about which database is live from one of the servers in the control database clusters and updates its local global variables. As a result, all database calls now go to the updated database. Each task invocation returns a success or failure value. When all tasks return values indicating success, the PAS 501 updates its message store to indicate successful completion.

The control tables may become inconsistent if Step 9, updating the control tables, fails (e.g., potentially one database may be updated but not the others). The PAS 501 reports a failure to update all the control tables as an error and the pipeline stage will not complete. If PAS 501 does not detect the error (e.g., the machine loses power while updating the tables), the stage fails without an error. However, this is caught in Step 5 where the PAS 501 checks for consistency across the control tables. PAS 501 stops processing with an error if this condition occurs.

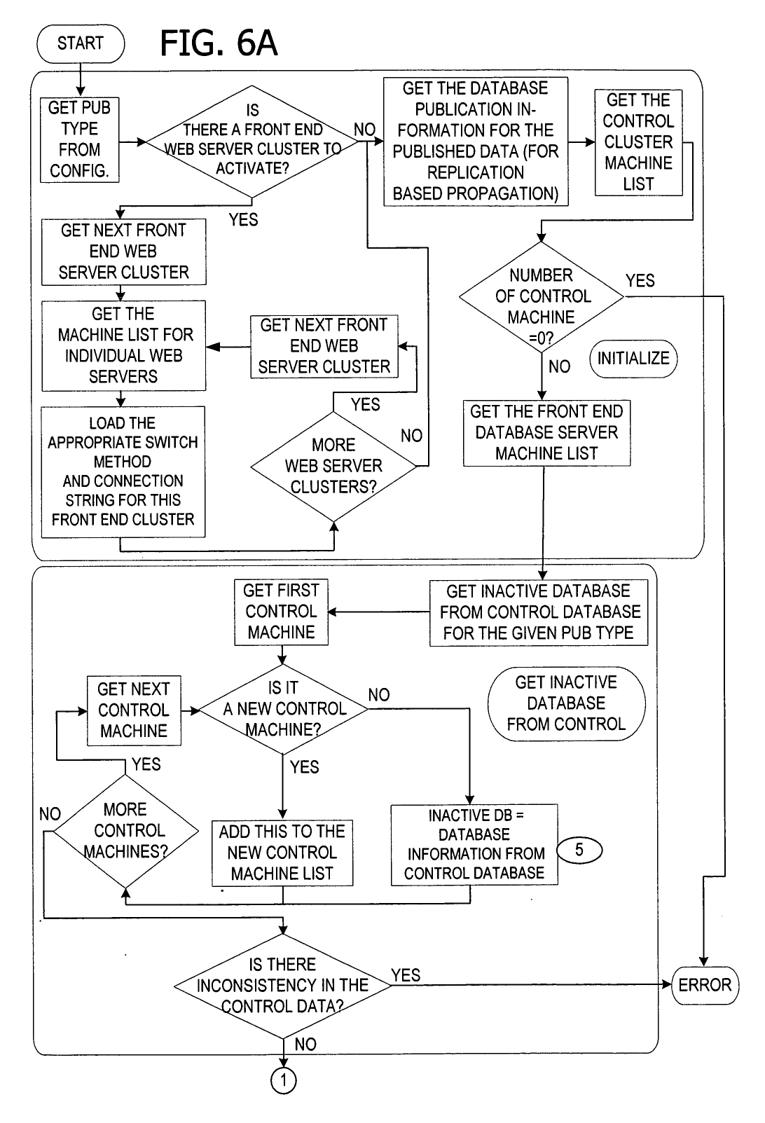

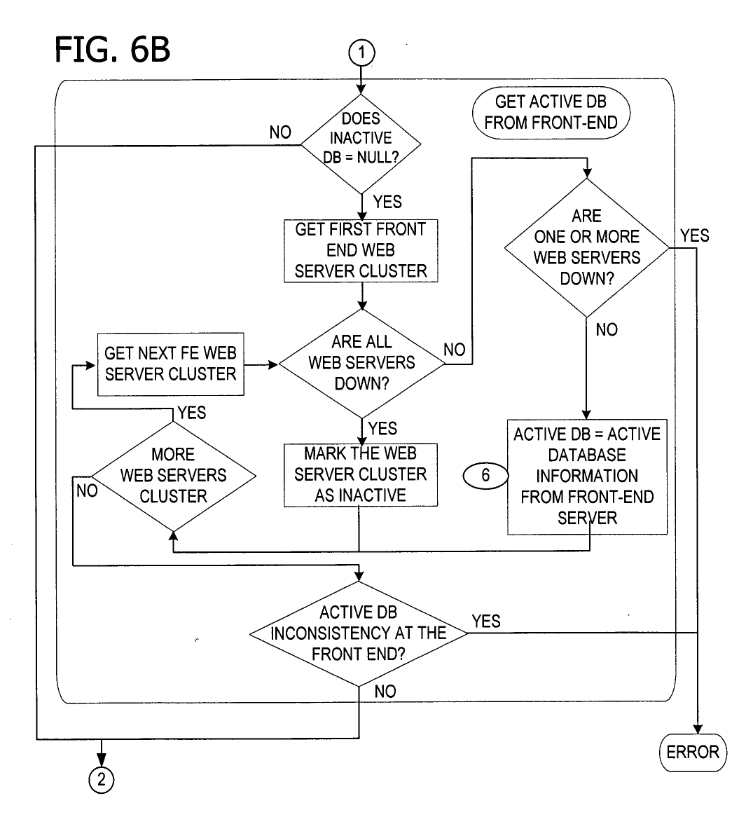

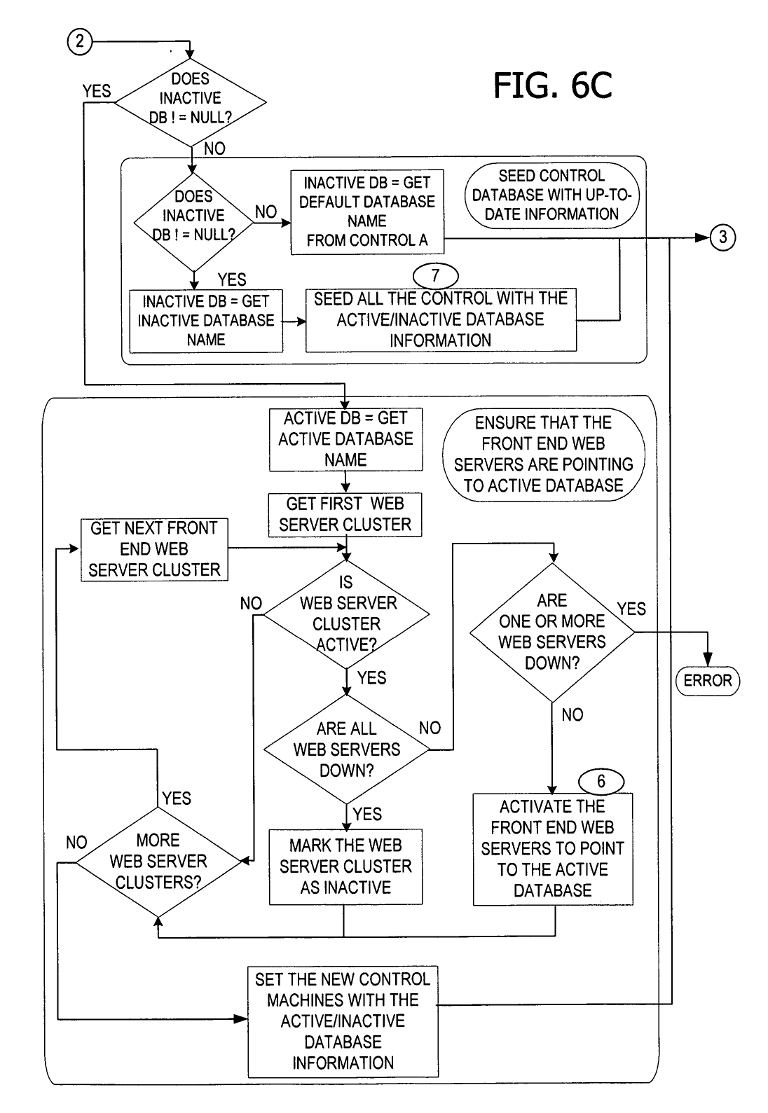

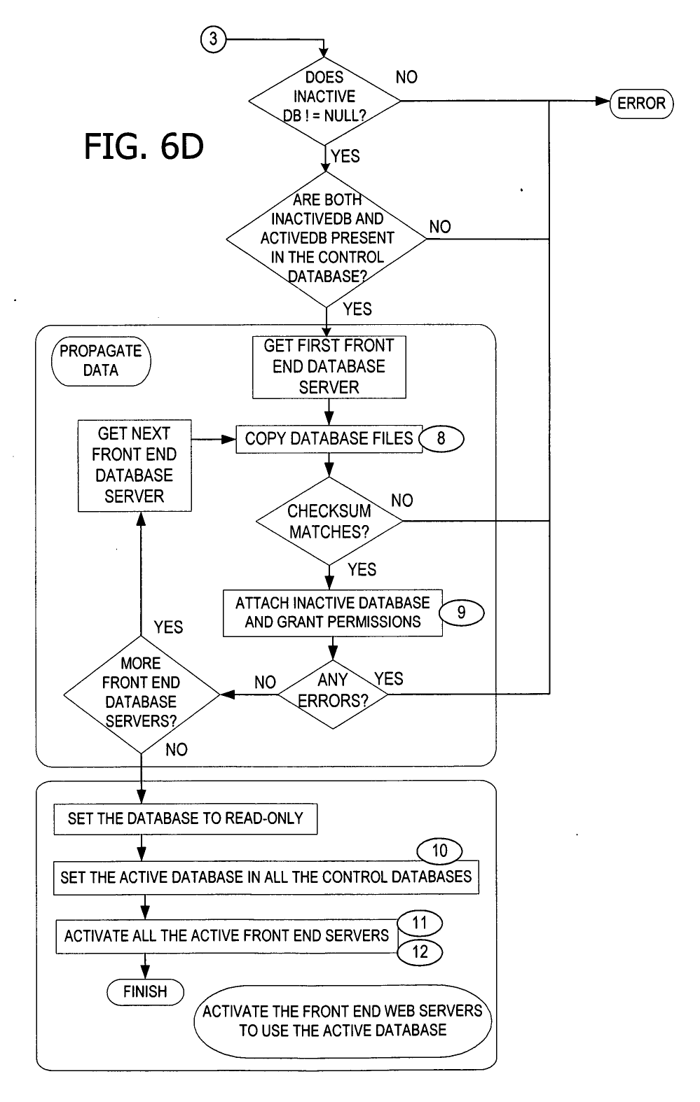

Referring next to FIG. 6A, FIG. 6B, FIG. 6C, and FIG. 6D, exemplary flow charts illustrate detailed operation of the publication activation service. In one embodiment, one or more computer-readable media have computer-executable instructions for performing the method illustrated in the figures. The circled numbers in the figures correspond to the operations illustrated in FIG. 5.

The PAS generates monitoring events to monitor failures when the data does not pass validation or when there is a problem with PAS replication, attach-detach, or the switch from offline to online.

Excerpts from an exemplary configuration file for the publication activation service (e.g., PubActivation.xml) are shown in Appendix A in addition to exemplary pipeline stage implementation for the PAS and the publication creation service.

The publication activation service supports a plurality of front-end servers. The web server properties are defined in a configuration section in a configuration file (e.g., PubActivation.xml) for the publication activation service. For each type of front-end, the MachineType, DB Switch Class, DB Switch Class assembly, DB Switch Connection Sting and Pub Type may be defined as shown below.

```
<FrontEndWebServer pipelinestage=“pas_games” desc=“vNext
Frontend Servers”>
  <MachineType>WEB-B-MACHINE</MachineType>
  <DBSwitchClass>
  Microsoft.WindowsMedia.Services.Platform.Common.Pub
  Activation.AsmxActivator.Switch.AsmxDBSwitch</DBSwitchClass>
  <DBSwitchClassAssembly>
  WindowsMedia.Services.Platform.Common.Pub
  Activation.“smxActivator.Switch</DBSwitchClassAssembly>
  <DBSwitchConnectionString>http://{0}:80/games/DBSwitch.asmx
  </DBSwitchConnectionString>
  <PubType>GAMES</PubType>
</FrontEndWebServer>
```

The publication activation service also supports the addition of a new front-end server. If a new front-end server is being added to a cluster or a new cluster is being added, the name of the front-end server is added to the configuration file. The publication activation service executes to recognize the new front-end server and to replicate or attach data into the current database. The new front-end server is then available to the other servers (e.g., the database servers).

New database servers are added to the configuration file. The database servers determine which database to use by querying the control database. The database to use can be specified for each particular type of front-end in the publication activation service configuration file as shown in the examples below. When the front-end requests a connection to a database web server, it determines the machine type and searches PubActivation.xml.

```
<BCDConnection>
<DataSource substitution=“BCD-FE-SQL-VIP-MACHINE” position=“1”/>
  <DualDbPubType>BCDMetadataDSN</DualDbPubType>
</BCDConnection>
<FrontEndWebServer pipelinestage=“pas_augment_bcd” desc=“vNext Frontend Servers”>
<MachineType>MUSIC-WEBFE-MACHINE</MachineType>
  <DBSwitchClass>XXX.PubActivation.AsmxActivator.Switch.AsmxDBSwitch</DBSwitchClass>
  <DBSwitchClassAssembly>XXX.PubActivation.AsmxActivator.Switch</DBSwitchClassAssemb
  <DBSwitchConnectionString>http://{0}:80/cdinfo/DBSwitch.asmx</DBSwitchConnectionString>
<PubType>BCDMetadataDSN</PubType>
</FrontEndWebServer>
<FrontEndWebServer pipelinestage=“pas_augment_bcd” desc=“vNext Frontend Servers
Tukwila”>
<MachineType>MUSIC-WEBFE-MACHINE-TK</MachineType>
  <DBSwitchClass>XXX.PubActivation.AsmxActivator.Switch.AsmxDBSwitch</DBSwitchClass>
  <DBSwitchClassAssembly>XXX.PubActivation.AsmxActivator.Switch</DBSwitchClassAssemb
  <DBSwitchConnectionString>http://{0}:80/cdinfo/DBSwitch.asmx</DBSwitchConnectionString>
<PubType>BCDMetadataDSN</PubType>
  <DBConnectionVIP name=“BCDConnection” substitution=“BCD-FE-SQL-VIP-MACHINE-
TK” position=“1”/>
  <DBConnectionVIP name=“ControlDbConnection” substitution=“CTRL-CLUST-
VIP-TK” position=“1”/>
</FrontEndWebServer>
```

The following example illustrates defining an override connection to a database web server.

<FrontEndWebServer pipelinestage=“pas_augment_bcd” desc=“vNext Frontend Servers”>
<MachineType>MUSIC-WEBFE-MACHINE</MachineType>
<DBSwitchClass>XXX.PubActivation.AsmxActivator.Switch.AsmxDBSwitch</DBSwitchClass>
<DBSwitchClassAssembly>XXX.PubActivation.AsmxActivator.Switch</DBSwitchClassAssemb
<DBSwitchConnectionString>http://{0}:80/cdinfo/DBSwitch.asmx</DBSwitchConnectionString>
<PubType>BCDMetadataDSN</PubType>
</FrontEndWebServer>
<FrontEndWebServer pipelinestage=“pas_augment_bcd” desc=“vNext Frontend Servers Tukwila”>
<MachineType>MUSIC-WEBFE-MACHINE-TK</MachineType>
<DBSwitchClass>XXX.PubActivation.AsmxActivator.Switch.AsmxDBSwitch</DBSwitchClass>
<DBSwitchClassAssembly>XXX.PubActivation.AsmxActivator.Switch</DBSwitchClassAssemb
<DBSwitchConnectionString>http://{0}:80/cdinfo/DBSwitch.asmx</DBSwitchConnectionString>
<PubType>BCDMetadataDSN</PubType>
<DBConnectionVIP name=“BCDConnection” substitution=“BCD-FE-SQL-VIP-MACHINE-TK”
position=“1”/>
<DBConnectionVIP name=“ControlDbConnection” substitution=“CTRL-CLUST-VIP-TK”
position=“1”/>
</FrontEndWebServer>

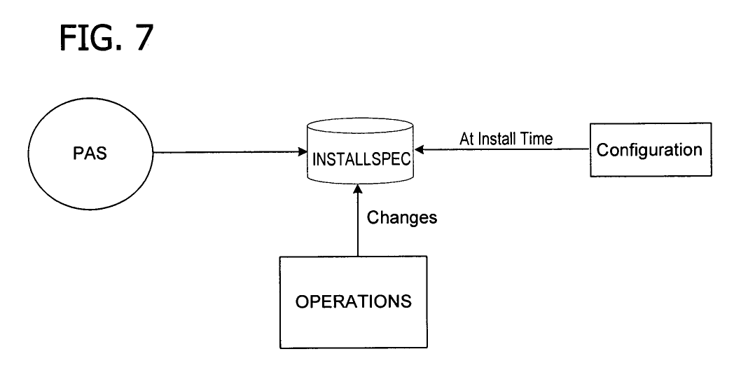

In one embodiment, administrators or operators make changes directly to the configuration file for the publication activation service. Changes include adding and/or removing the computing devices. In another embodiment, the publication activation services reads information about the computing devices (e.g., the database web servers and the front-end servers) directly from the database. Administrators thus make changes to the database as shown in FIG. 7. In such an embodiment, the database is populated with machine type and name information such as shown in the schema in Table 1 below.

TABLE 1
Exemplary Schema for Database.

| Column Name | Column Type |
|---|---|
| MachineType | Varchar(256) |
| MachineName | Varchar(256) |
| Active | Bit |

The publication activation service uses a procedure to get the latest active server name associated with the particular MachineType from the database.

The exemplary operating environments illustrated in the figures include a general purpose computing device such as a computer executing computer-executable instructions. The computing device typically has at least some form of computer readable media. Computer readable media, which include both volatile and nonvolatile media, removable and non-removable media, may be any available medium that may be accessed by the general purpose computing device. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media. The computing device includes or has access to computer storage media in the form of removable and/or non-removable, volatile and/or nonvolatile memory. The computing device may operate in a networked environment using logical connections to one or more remote computers.

Although described in connection with an exemplary computing system environment, aspects of the invention are operational with numerous other general purpose or special purpose computing system environments or configurations. The computing system environment is not intended to suggest any limitation as to the scope of use or functionality of aspects of the invention. Moreover, the computing system environment should not be interpreted as having any dependency or requirement relating to any one or combination of components illustrated in the exemplary operating environment. Examples of well known computing systems, environments, and/or configurations that may be suitable for use in embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Aspects of the invention described herein includes these and other various types of computer-readable storage media when such media contain instructions or programs for implementing the steps described below in conjunction with a microprocessor or other data processor. Further, aspects of the invention include the computer itself when programmed according to the methods and techniques described herein.

Aspects of the invention may also be practiced in distributed computing environments where tasks are performed by remote processing devices that are linked through a communications network. In a distributed computing environment, program modules may be located in both local and remote computer storage media including memory storage devices.

In operation, a computer executes computer-executable instructions such as those illustrated in the figures to implement aspects of the invention. Further, hardware, software, firmware, computer-executable components, computer-executable instructions, and/or the elements of the figures constitute means for receiving an indication of an update to a data file associated with one or more of a plurality of databases, means for creating indexes based on the updated data file, means for identifying the one or more of the plurality of databases based on the received indication, means for detaching each of the identified one or more of the plurality of databases from a database server instance associated therewith, means for copying the updated data file and the created indexes to each of the detached one or more of the plurality of databases to update each of the detached one or more of the plurality of databases, and means for attaching each of the updated one or more of the plurality of databases to the database server instance associated therewith.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

Excerpts from an exemplary configuration file for the publication activation service (e.g., PubActivation.xml) are shown below in addition to exemplary pipeline stage implementation for the PAS and the publication creation service.

```
<FrontEndWebServers>
  <FrontEndWebServer pipelinestage=“pas_games” desc=“vNext
Frontend Servers”>
<MachineType>WEB-B-MACHINE</MachineType>
<DBSwitchClass>Microsoft.WindowsMedia.Services.Platform.Common.-
PubActivation.AsmxActivator.Switch.AsmxDBSwitch</DBSwitchClass>
<DBSwitchClassAssembly>WindowsMedia.Services.Platform.Common.-
PubActivation.“smxActivator.Switch</DBSwitchClassAssembly>
  <DBSwitchConnectionString>http://{0}:80/games/DBSwitch.asmx
  </DBSwitchConnectionString>
  <PubType>GAMES</PubType>
    </FrontEndWebServer>
    <FrontEndWebServer pipelinestage=“pas_games”
desc=“vCurrent Frontend Servers”>
<MachineType>WEB-B-MACHINE</MachineType>
<DBSwitchClass>Microsoft.WindowsMedia.Services.Platform.Common.-
PubActivation.AspActivator.Switch.AspDBSwitch</DBSwitchClass>
<DBSwitchClassAssembly>WindowsMedia.Services.Platform.Common.-
PubActivation.“spActivator.Switch</DBSwitchClassAssembly>
  <DBSwitchConnectionString>http://{0}:80/ASPReload/Reload.asp
  </DBSwitchConnectionString>
      <PubType>GAMES</PubType>
    </FrontEndWebServer>
  </FrontEndWebServers>
```

Pipelinestage: Name of the corresponding PAS pipeline stage.
Desc: Description of the Front-end server type.
MachineType: Front-end web server Machine type, the actual machine list will be resolved from the InstallSpec at the runtime.
DBSwitchClass: Name of the DB Switch Class to use for activation
DBSwitchClassAssembly: Name of the corresponding DB Switch Class assembly.
DBSwitchConnectionString: URL string used for the actual activation, it can point to the web services, or the ASP page
PubType: Pub Type

Sample PAS Pipeline Stage

```
<PipelineStage appName=“pas_games” schema=“PipelineStage.xsd”
featureSet=“GAMES_PAS”>
    <WorkingDir volume=“GAMES_PAS_PIPELINE”/>
    <InputPipes>
      <NullInputPipe appName=“pcs_games”/>
    </InputPipes>
    <Process>
      <Moniker name=“Process” schema=“Factory.xsd”>
        <Local schema=“Factory.xsd”>
<TypeName>Microsoft.WindowsMedia.Services.Platform.Common.-
PubActivation.Manager.PubActivation</TypeName>
<AssemblyName>%installdir%bin\WindowsMedia.Services.Platform.-
Common.PubActivation.Manager.dll</AssemblyName>
<ConstructorArgument name=“appName”
type=“System.String”>pas_games</ConstructorArgument>
        </Local>
      </Moniker>
<Parameter name=“ServerConnection”>
CONTROL_DB_CONNECTION</Parameter>
<Parameter name=“ControlClusterMachineType”>CTRL-CLUST-
MACHINE</Parameter>
<RefParameter appName=“pcs_games” attribute=“appName”
variable=“PublisherAppName”/>
<RefParameter appName=“pcs_games” attribute=“publicationName”
variable=“PublicationName”/>
<RefParameter appName=“pcs_games” attribute=“version”
variable=“InputVersion”/>
  </Process>
    <MessageStore appName=“pas_games”
volume=“GAMES_PAS_PIPELINE”>
      <ExecutionDependency operator=“OR”>
        <App appName=“pcs_games”/>
      </ExecutionDependency>
    </MessageStore>
  </PipelineStage>
```

Sample Publication Creation Service Pipeline Stage:

```
<PipelineStage appName=“pcs_games” schema=“PipelineStage.xsd”
featureSet=“GAMES_PCS”>
    <WorkingDir volume=“GAMES_PAS_PIPELINE”/>
    <Database name=“pcs_games”>
      <Server substitution=“GAMES-PAS-MACHINE”
position=“1”/>
    </Database>
    <InputPipes>
<DBSubscribeInputPipe appName=“dps_games”
publicationName=“dps_games”/>
    </InputPipes>
    <OutputPipes>
<DBDetachOutputPipe dbName=“pcs_games” resizeLogMB=“1400”
compress=“true”>
  <TemplateDataFileLocation>h:\template_dbs</
TemplateDataFileLocation>
  <TemplateLogFileLocation>o:\template_dbs</
TemplateLogFileLocation>
  <WorkDataFileLocation>H:\MSSQL\DATA</WorkDataFileLocation>
  <WorkLogFileLocation>O:\MSSQL\DATA</WorkLogFileLocation>
</DBDetachOutputPipe>
    </OutputPipes>
    <MessageStore appName=“pcs_games”
volume=“GAMES_PAS_PIPELINE”>
      <ExecutionDependency operator=“OR”>
        <App appName=“dps_games”/>
      </ExecutionDependency>
    </MessageStore>
  </PipelineStage>
```

What is claimed is:

1. A method comprising:
receiving an indication of an update to a data file;
receiving one or more indexes created based on the updated data file;
identifying a database associated with a database server instance based on the received indication;
removing database files associated with the identified database from the database server instance;
associating the updated data file and the received indexes with the database server instance in place of the removed database files;
notifying a computing device associated with the database server instance to access the identified database including the updated data file and the received indexes.

2. The method of claim 1, wherein identifying the database associated with the database server instance comprises identifying an inactive database associated with the database server instance.

3. The method of claim 1, wherein removing the database files associated with the identified database from the database server instance comprises detaching the identified database from the database server instance.

4. The method of claim 3, wherein associating the updated data file and the received indexes with the database server instance comprises attaching the detached database to the database server instance.

5. The method of claim 1, wherein notifying a computing device associated with the database server instance to access the identified database comprises updating a control table accessible to the database server instance to direct data operations to the identified database.

6. The method of claim 1, further comprising validating the updated data file.

7. The method of claim 1, further comprising updating version information based on the updated data file and the received indexes.

8. The method of claim 1, wherein notifying the computing device comprises notifying at least one of a plurality of computing devices, and further comprising adding another computing device to the plurality of computing devices via a configuration file.

9. The method of claim 1, wherein one or more computer-readable media have computer-executable instructions for performing the method of claim 1.

10. One or more computer-readable media having computer-executable components comprising:
a signal component for receiving an indication of an update to a data file associated with a database;
a population component for creating an index based on the updated data file;
a validation component for validating the updated data file and the index created by the propagation component;
a detach component for removing, from the database server instance, database files associated with the database;
a propagation component for replacing the database files removed by the detach component with the updated data file validated by the validation component and the index created by the population component; and
an attach component for associating the updated data file and the index with the database-server instance in place of the database files removed by the detach component to update the database.

11. The computer-readable media of claim 10, wherein the population component executes prior to execution of the detach component, propagation component, and attach component.

12. The computer-readable media of claim 10, further comprising an activation component for notifying a computing device associated with the database server instance to access the database including the updated data file and the received indexes.

13. A system comprising:
means for receiving an indication of an update to a data file associated with one or more of a plurality of databases;
means for creating indexes based on the updated data file;
means for identifying the one or more of the plurality of databases based on the received indication;
means for detaching each of the identified one or more of the plurality of databases from a database server instance associated therewith;
means for copying the updated data file and the created indexes to each of the detached one or more of the plurality of databases to update each of the detached one or more of the plurality of databases; and
means for attaching each of the updated one or more of the plurality of databases to the database server instance associated therewith.

14. The system of claim 13, further comprising a memory area for storing a configuration file defining a plurality of database server instances and a plurality of database web servers.

15. The system of claim 14, wherein the configuration file comprises a field for specifying a machine type for each of the plurality of database server instances and for each of the plurality of database web servers, wherein the machine type corresponds to the one of the plurality of databases.

16. The system of claim 13, further comprising a memory area for storing a control table accessible by the database server instance for identifying an active database.

17. The system of claim 16, further comprising a processor configured to execute computer-executable instructions for validating the control table.

18. The system of claim 16, further comprising a processor configured to execute computer-executable instructions for updating the control table to direct data operations to the updated one or more of the plurality of databases.

19. The system of claim 13, further comprising a processor configured to execute computer-executable instructions for validating the updated data file.

20. The system of claim 13, wherein the updated database file and the created indexes constitute database files.
